(19) United States
(12) Patent Application Publication
(10) Pub. No.: US 2005/0050942 A1
(43) Pub. Date: Mar. 10, 2005

(54) Wear test system

(76) Inventor: Edward A. Schmitt, Richboro, PA (US)

Correspondence Address: ROHM AND HAAS COMPANY;PATENT DEPARTMENT, 100 INDEPENDENCE MALL WEST, PHILADELPHIA, PA, 19106-2399, US

(21) Appl. No.: 10/231,516

(22) Filed: Aug. 30, 2002

Related U.S. Application Data
(60) Provisional application No. 60/318,116, filed on Sep. 7, 2001.

(51) Int. Cl. G01N 19/02

(52) U.S. Cl. 73/7; 356/446

(57) ABSTRACT

A wear test system for monitoring wear of a sample including a test material located on a base surface of a contrasting color. The system includes a scrub machine with a scrub device mounted for movement over a defined path on the sample. A camera is located above the defined path in a test monitoring area, and a controller is connected to the scrub machine and the camera. The controller creates time evolved composite wear data for wear of the test material from the sample.

### BACKGROUND

The present invention relates to a wear test system for testing abrasion and/or scrub resistance of materials. More particularly, the invention relates to a system and method for high throughput automated testing of wear resistance of coatings applied on a substrate.

The development of coating formulations, such as for paint, requires a large amount of testing which is both labor intensive and time consuming. Numerous properties must be tested to determine whether a particular formulation is suitable for a desired application. Various qualities for coating formulations are tested in order to derive an optimal balance of desired properties. In the case of paints, these properties relate to the decorative as well as the functional qualities of the product.

One known test which is performed on various coating formulations is a scrub resistance test. This is typically done in accordance with ASTM D2486 or an industry accepted variation thereof, and requires substantial time and operator attention during testing. The known test strip is prepared by applying a 3-mil drawdown of paint to a black plastic panel, which is then conditioned, as desired, through aging and drying. The ASTM procedure specifies a seven day drying period at constant temperature and humidity. However, different procedures may be used in preparing the samples, depending upon the particular testing.

Typically, such samples are then mounted in a Gardner scrub machine. A shim is located under each test location on the test strip. The scrub machine is turned on, and scrub brushes are moved back and forth in strokes over the sample. A scrub medium, such as industrial cleaner, is applied to the scrub brush. The machine counts the strokes and an observer watching the test observes the samples to determine when initial break through occurs, as well as when certain levels of wear through are observed on each sample. In the case of the known equipment, an observer is required to monitor the equipment during the entire test, and it is often necessary to stop the scrub machine in order to wipe the samples clear of the scrub medium in order to make accurate observations. It is also necessary for the operator to make qualitative judgments, which can vary by operator, introducing human error. Additionally, the volume of scrub medium being applied is generally manually controlled, which may result in different amounts of scrub medium being used which can distort observations as well as cause inaccurate test results.

It has also been proposed to modify this known type of equipment to provide a camera for observing the test strip in the wear area. In this proposed modification, the scrub machine is stopped and digitally controlled wipers are used to clear scrub media from the test panel before an image is taken. While this provides for accurate imaging, it requires a complex brush interlock control system as well as wiping mechanism in order to wipe the test panel prior to imaging. This proposed system also requires that the user specify the number of cycles for each imaging interval since the brush assembly must be stopped and the sample wiped prior to imaging.

It would be desirable to provide an automated wear test system for monitoring wear of a sample which does not require operator action during testing, and which can provide fast, consistent and accurate testing of samples along with supporting data for analysis after testing has been completed.

### STATEMENT OF INVENTION

Briefly stated, the present invention provides a wear test system for monitoring wear of a sample including a test material located on a base surface of a contrasting color. A scrub machine is provided having a scrub device mounted for movement over a defined path upon which the sample is adapted to be placed. A camera is located above the defined path in a test monitoring area. A controller is connected to the scrub device and the camera and receives data on movement of the scrub device and image data from the camera. The controller creates time evolved composite wear data for wear of the test material from the sample.

In another aspect, the invention provides a method of testing and monitoring wear of a sample including a test material located on a base surface of a contrasting color. The method includes:
scrubbing the test material on the base surface with the scrub device;
imaging at least a portion of the test sample at defined intervals with a camera, generating image data;
transmitting the image data to a controller; and
creating time evolved composite wear data for wear of the test material from the sample.

The following detailed description of the preferred embodiments of the invention will be better understood when read in conjunction with the appended drawings. In the drawings:

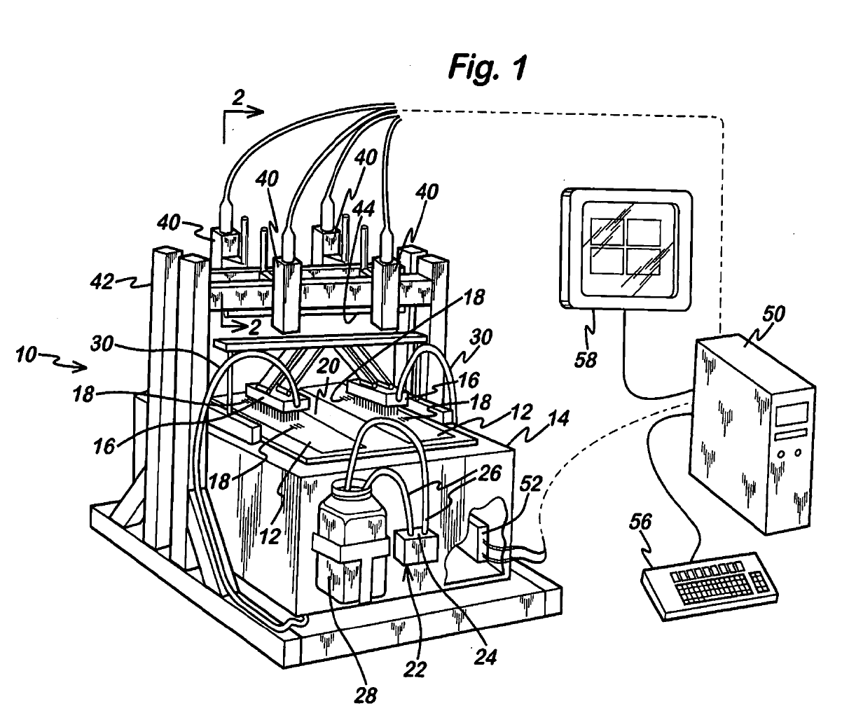

FIG. 1 is a perspective view of a wear test system in accordance with the present invention;

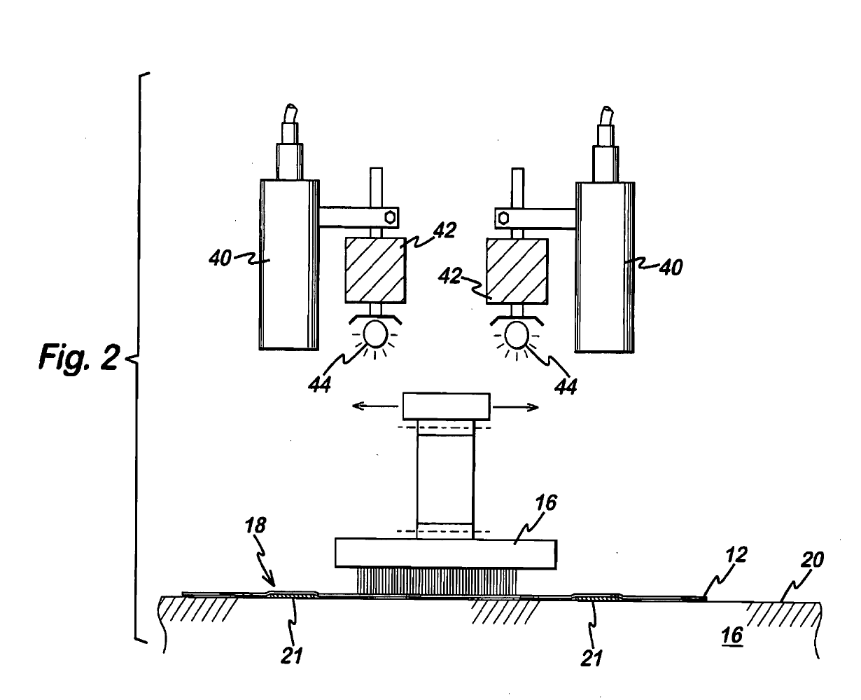

FIG. 2 is a cross-sectional view taken along line 2-2 in FIG. 1;

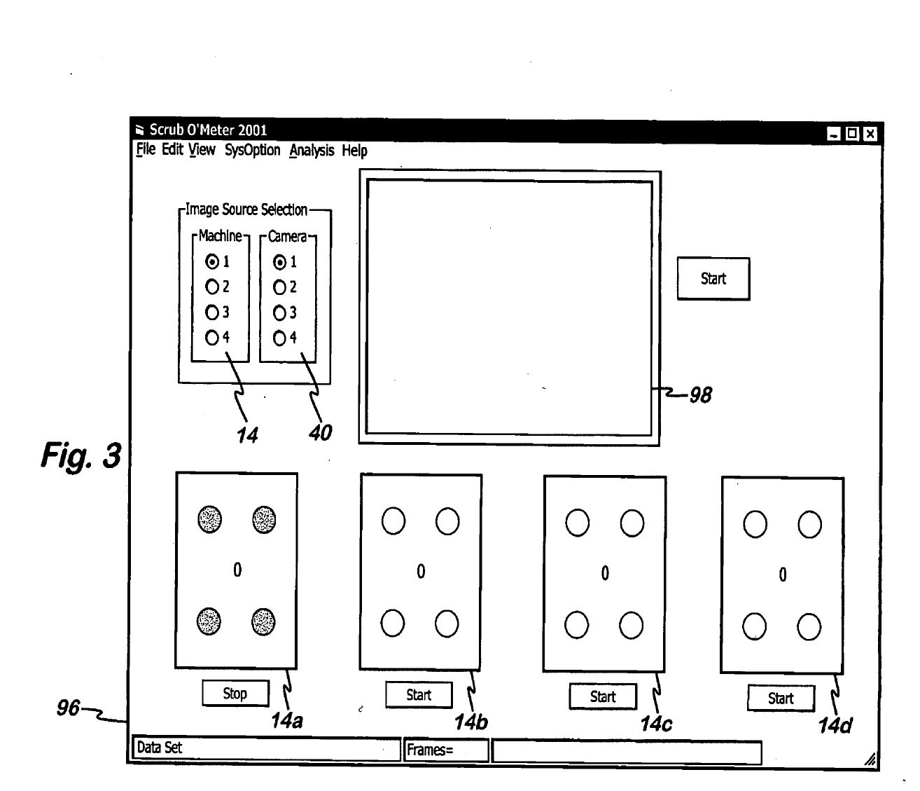

FIG. 3 is a view of a preferred user information display for control of multiple wear test devices;

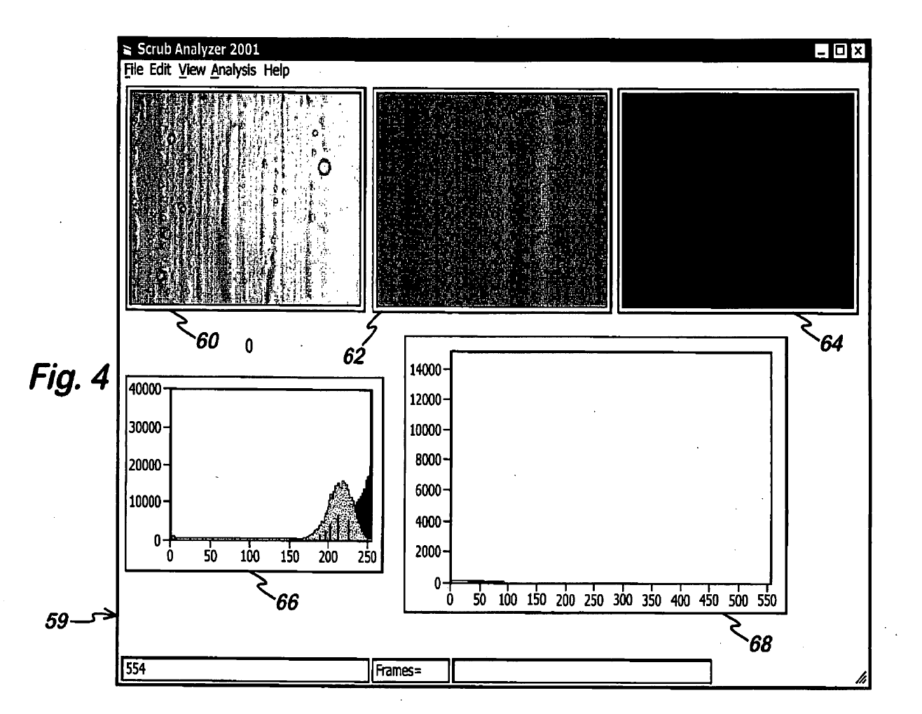

FIG. 4 is a view of a preferred user information display of the analysis provided by the wear test system, shown at the beginning of a wear test;

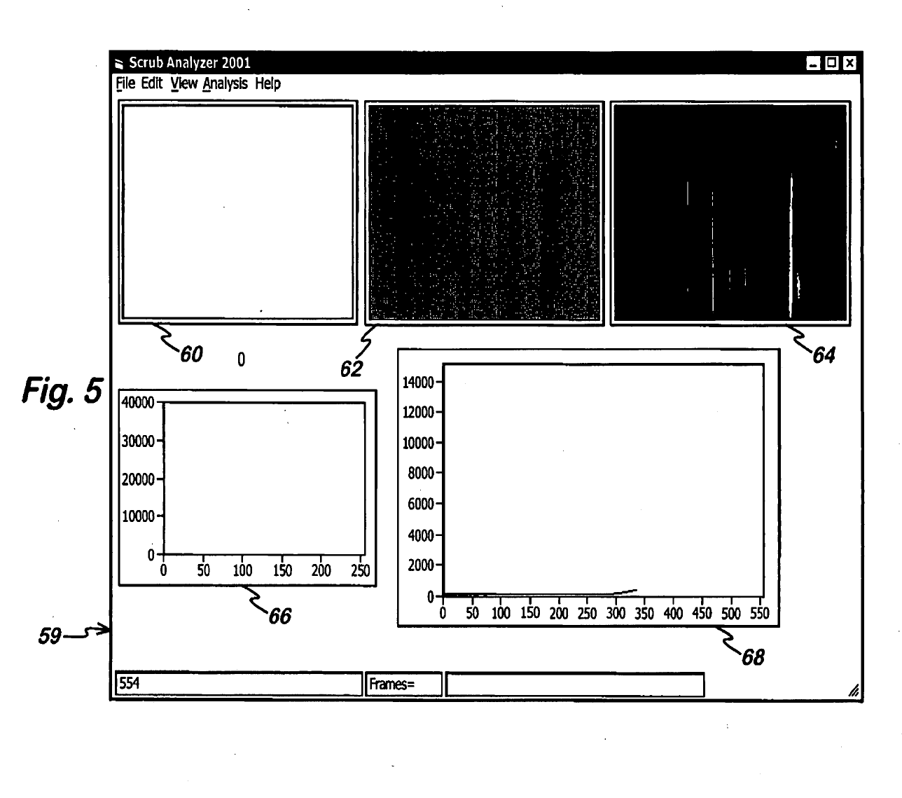

FIG. 5 is a view similar to FIG. 4 showing the analysis display approximately mid-way through the wear test;

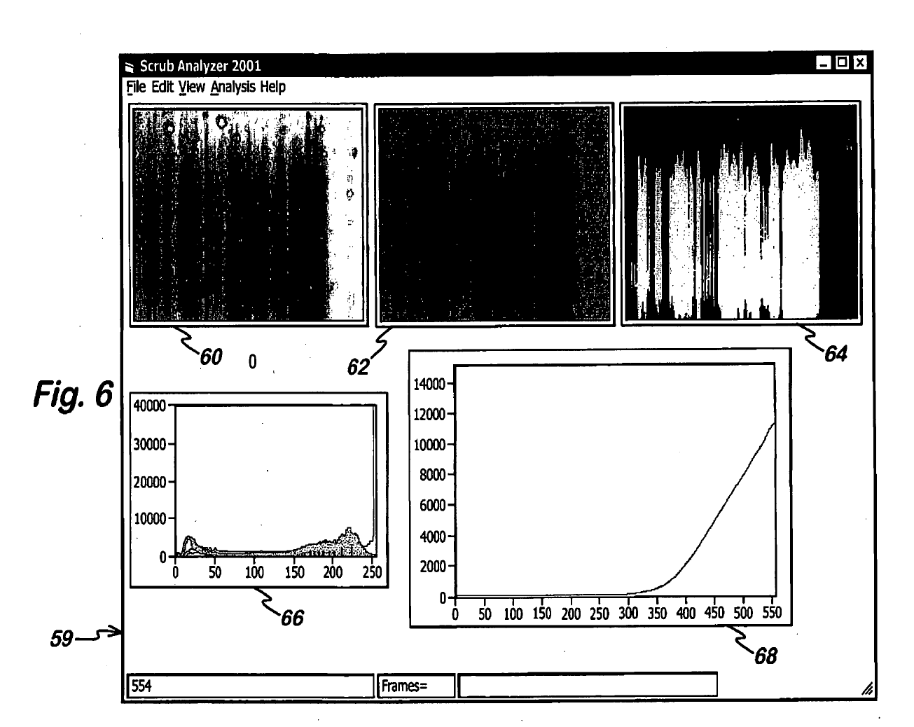

FIG. 6 is a view similar to FIGS. 4 and 5 showing the wear test analysis display at the completion of the wear test; and

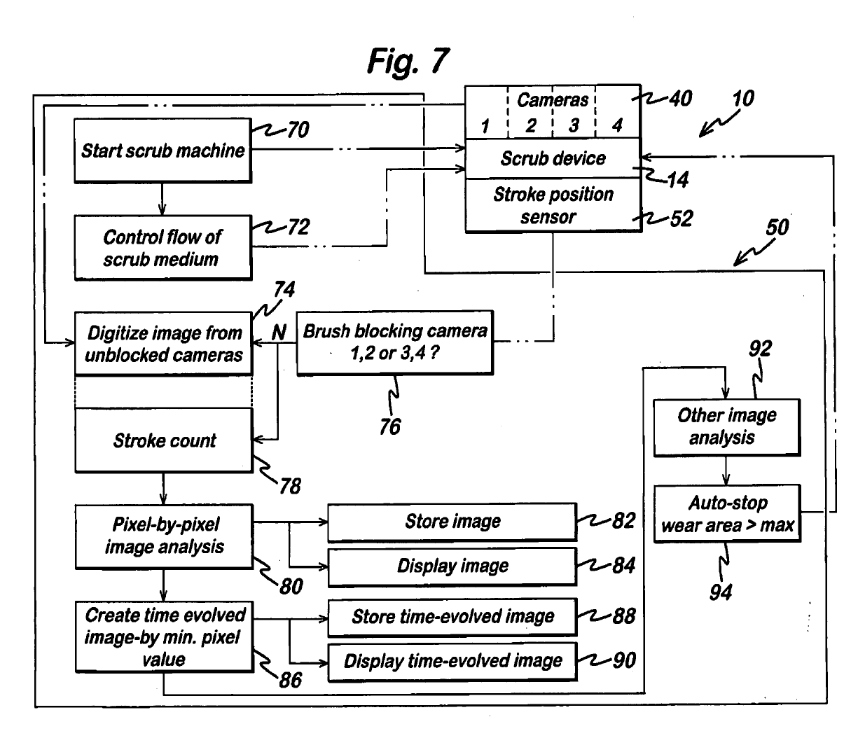

FIG. 7 is a schematic flow diagram showing the function of the wear test system of FIG. 1.

### DETAILED DESCRIPTION

Referring to FIG. 1, a wear test system 10 in accordance with the present invention is shown. The wear test system 10 is used for monitoring a sample 12 which includes a test material located on a base surface, preferably of a contrasting color. The system 10 includes a scrub machine 14 having a scrub device 16 mounted for movement over a defined path upon which the sample 12 is adapted to be placed. In the preferred embodiment, the scrub device 16 is preferably a brush which is moved back and forth in strokes along a generally linear path. In the preferred embodiment, an industry standard GARDNER™ dual track abrasion tester was used for the scrub machine 14. The GARDNER™ dual track abrasion tester 14 includes two scrub devices 16 in the form of brushes which are mounted for movement along two parallel paths on a sample mounting surface 20 so that two samples can be tested at the same time, with two test areas being analyzed on each sample. While the preferred embodiment of the scrub device 16 is a brush, as used herein the term “scrub device” is intended to refer to any scrubbing or abrading medium, for example scrub pads, sponges, sand paper or other abrasives.

A scrub medium delivery system 22 is preferably provided which delivers a scrub medium, which preferably has a contrasting color from the base surface, to the scrub device 16. The scrub medium is preferably the standard abrasive scrub medium for testing paint samples, but may be a polishing compound, an abrasive grit, an acid or etching medium, cleaners, soap (in which bubbles may give a contrasting color), or water. It is also possible to operate the test with no scrub medium, and just use the scrub device 16 itself. In the preferred embodiment, the scrub abrasion medium delivery system 22 comprises a pump 24 having hoses 26 which draw the scrub medium from a reservoir 28, and pump the scrub medium through hoses 30 to the scrub devices 16. While any type of pump 24 may be used, it is preferred that a peristaltic pump be provided so that a controlled amount of scrub medium can be delivered to each scrub device 16.

At least one camera 40 is located above the defined path in a testing monitoring area 18 for the sample 12. In the preferred embodiment, four cameras 40 are mounted on a support frame 42 to monitor four separate test areas 18, two on each test strip. It will be recognized by those in the skilled in the art that the number of cameras can be varied depending upon the number of scrub devices 16 and test areas per scrub device. In the preferred embodiment, the cameras 40 are black and white analog cameras which are focused on the samples 12 above the test monitoring areas. However, other types of cameras, suchas a digital camera could be used. Preferably, lights 44 are mounted to the frame 42 in proximity to the camera provide illumination for imaging. The lights may be fluorescent tubes, light pipes or any other suitable lighting.

A controller 50 is connected to the scrub machine 14 and the cameras 40. The controller is preferably a PC having a Pentium III processor or higher running at 300 megahertz or higher. However, other types of controllers may be utilized. The controller 50 is also connected to a stroke position sensor 52 which detects the position of the scrub device 16 and signals the stroke position to the controller 50. In a preferred embodiment, the stroke position sensor 52 is connected to the stroke drive mechanism and produces a square wave signal to indicate when the scrub device 16 is at least one end of the stroke. The controller 50 also controls the acquisition of image data from the cameras 40. In the preferred embodiment utilizing the GARDNER™ dual track abrasion tester, each sample 12 is tested in two separate locations and the scrub device 16 alternately blocks the camera view in one of the test monitoring areas 18. The controller 50 therefore receives the electrical signal from the stroke position sensor 52 and then digitizes the video signal from the camera 40 so that the image for each test monitoring area 18 is acquired when the scrub device 16 is located at the opposite end of its stroke. The controller 50 creates time evolved composite wear data for wear of the test material from the sample based on the image data collected with each stroke.

Preferably, a keyboard 56 is connected to the controller as a user interface and a monitor 58 is provided for visual output. The controller may also be connected to a printer in order to print images and/or analysis based on the time evolved composite wear data.

Referring now to FIG. 2, the position of the cameras 40 over the test monitoring areas 18 is clearly shown. The test sample is preferably mounted on a surface 20 of the scrub machine 14 and, in accordance with the usual test procedures, shims 21 are placed beneath the sample 12 in the test monitoring areas 18. While this may be appropriate for certain types of testing, those skilled in the art will recognize that the use of shims is optional, depending upon the type of testing, and that the size of the shims can be varied.

In the preferred embodiment, the sample 12 is formed from a three-mil draw-down of paint applied to a dark plastic panel which acts as the base surface. However, other types of samples can be provided, depending upon the particular testing to be carried out. Preferably, the coating material is a white paint and the base surface is black. Additionally, the scrub medium is also preferably white or a light color which is easily contrasted against the black base surface of the sample.

Referring to FIG. 7, the controller 50 is preferably programmed to start the scrub machine after at least one sample 12 has been installed, as shown in box 70. The controller 50 also controls the flow of the scrub medium by turning the peristaltic pump off and on so that a measured amount of scrub medium is delivered to the scrub device 16, as shown in box 72. If multiple samples are being tested at the same time, controlled flow of scrub medium to each of the samples can be provided by separate peristaltic pumps or by a control valve which switches output to the pump 24 or as a single pump with multiple heads to the different scrub devices 16, at predetermined intervals. The controller 50 acquires images from the unblocked cameras for each stroke of the scrub machine 14, as shown in box 74. This is triggered by the stroke position sensor 52 on the scrub device. If the brush 16 is blocking the cameras on one side of the scrub device 14, the image from the opposite side is acquired, as shown in box 76. The controller 50 also uses the trigger from the position sensor 52 to count the strokes, as shown in box 78, so that each acquired image from each test monitoring area 18 for a sample 12 can be associated with a stroke count. Software in the controller 50 is used to do a pixel-by-pixel image analysis, as shown in box 80 to determine the pixel value for each defined unit area, which is preferably set at one pixel, which encompasses at least a portion of the sample being analyzed. The first embodiment, the analog image for each test monitoring area is converted into a 640×480 pixel image and pixel value determined for each pixel. In the preferred embodiment, the values range from zero for black to 255 for white. The image data for each test monitoring area 18 for each stroke can be stored, as shown in box 82, and/or displayed, as shown in box 84, for example as shown in the first view area 60 of the wear test system analysis display 59, as shown in FIGS. 4-6.

The controller then creates a time evolved composite image, as shown in box 86 in FIG. 7, which can be displayed, for example, as shown in the second viewing area 62 in FIGS. 4-6. The minimum value for each of the pixels in the test monitoring area 18 is stored, as shown in box 88 in FIG. 7, and/or displayed, as shown in box 90. By storing the time-evolved composite image, the present wear test system 10 eliminates the need to stop the scrub machine 14 in order to wipe the sample 12 being tested in order to obtain a clear image. Based upon the time-evolved composite image, areas of the material being tested which have worn through to the base surface which may be obscured by the scrub medium or scrub generated debris on one stroke are generally cleared in one or more subsequent strokes. By storing the minimum pixel value for each defined unit (pixel) area over the entire test, this provides the effect of filtering out the scrub medium and/or scrub generated debris from the obscured areas to provide an accurate state of the test sample 12.

The controller 50 may also apply a threshold value to the time evolved-composite data for visualization as shown in the third view area 64 in FIGS. 4-6, or perform other image analysis, as indicated in box 92 in FIG. 7. For example, when the threshold value is applied, any pixel having a value of 50 or less may be considered worn through and any pixel having a value greater than 50 can be considered not worn through. For imaging purposes, the third view area 64 is reversed such that the worn through areas are shown as white and the areas in which the test material has not worn through are shown as black.

Other data can be analyzed from the images as shown in the first histogram 66 in FIGS. 4-6 which provides an intensity histogram or is shown in the second histogram 68 which provides a measured image statistic. Other algorithms and new measurements may be developed based upon this captured data without the need for human observation or intervention during the data acquisition.

Additionally, the controller 50 can automatically shut of the scrub device 14 once it determines that a wear area has exceeded a maximum limit for the test monitoring area 18, as shown in box 94 in FIG. 7.

In connection with the wear test system 10 in accordance with the present invention, it is possible to provide a scrub medium having a dye which is discernable from the base surface. For example, the scrub medium can be dyed a certain color which is easily filtered out using a color optical filter. It may also be possible to use a dye which includes a UV discernable material and for the imaging to be done using a UV sensitive camera.

It is also possible for the controller 50 to be used to control multiple scrub machines 14. As shown in FIG. 3 which provides an example of a control screen 96, the controller 50 can be connected to several different machines l4, for example four machines are represented as 14a-d, so that multiple tests can be carried out on multiple machines at the same time by a single operator. Each scrub machine 14 can be controlled independently and image data from each test acquired, stored and analyzed in accordance with predetermined or preprogrammed parameters. The current image from any of the cameras 40 of any of the machines 14a-d can also be displayed in image area 98.

A method of testing and monitoring wear of a sample 12 having a test material located on a base surface, for example a white paint located on a black test panel may be carried out as follows. The sample 12 is mounted on a mounting surface 20 of the test machine 14, as shown in FIGS. 1 and 2. An appropriate scrub medium, such as a detergent cleaner or an abrasive may be placed in the reservoir, or no scrub medium can be used, depending on the particular test. The controller 50 then starts the scrub machine and, preferably controls the flow of scrub medium to the scrub device 16. The scrub device 16 scrubs the test material on the base surface and at least a portion of the test sample 12 is imaged with a camera 40 at defined intervals generating an image signal. The image signal is transmitted to the controller 50, which also complies the stroke count associated with each image based on the signal from the stroke position sensor 52. The controller 50 can convert each analog image received to a digital image and store the image data and/or display the image. The controller then creates time evolved composite wear data for the portion of the test monitoring area 18 being observed, for example by storing and/or displaying the minimum pixel value on a pixel-by-pixel basis. This has the advantage of filtering out the scrub medium and/or scrub generated debris which may obscure one or more pixels of the image in any given stroke. The controller 50 may calculate the total area based on the defined unit area of each pixel or based on other defined unit areas which can be used for analysis of coating wear based on the test conditions. The controller 50 may calculate various parameters v. stroke, such as: (1) total worn area; (2) subregion widths for wear of separate subregions worn through in the test area; (3) subregion lengths or any other desired spatial metric, for example, such as ellipse axes which may be used to provide a more accurate estimate or worn areas or subregions, depending upon a number of factors.

Based upon the ability of the controller 50 to store the data for each test monitoring area 18 of one or several samples at the same time, it is now possible to perform higher throughput testing and analysis of wear data for test material located on a base surface than was previously possible using the prior known systems. Additionally, the controller 50 can be programmed to automatically carry out various different types of analysis.

This device may be adapted for use testing in the following applications:
(1) aggregrate composites (such as EIFS—exterior insulating and finishing systems);
(2) cementicious materials;
(3) glass bead adhesion in road-marking applications;
(4) stain-resistance, stain removal;
(5) solvent resistance;
(6) alkali resistance;
(7) cleaner resistance; and
(8) erosion of metals (such as gold and copper) in electronics applications (such chemical-mechanical planarization.

1. A wear test system for monitoring wear of a sample including a test material located on a base surface of a contrasting color, comprising:
a scrub machine having a scrub device mounted for movement over a defined path upon which the sample is adapted to be placed;
a camera located above the defined path in a test monitoring area; and
a controller connected to the scrub machine and the camera which receives data on movement of the scrub device and image data from the camera, the controller creates time evolved composite wear data for wear of the test material from the sample.

2. The wear test system of claim 1, wherein the controller stores the image data from the camera in defined unit areas which encompass at least a portion of the sample.

3. The wear test system of claim 2, wherein the defined unit area is equal to a pixel.

4. The wear test system of claim 1, further comprising a scrub medium delivery system which delivers a scrub medium to the scrub device.

5. The wear test system of claim 4, wherein the scrub medium has a contrasting color from the base surface

6. The wear test system of claim 4, wherein the controller stores the image data from the camera in defined unit areas which encompass at least a portion of the sample, and the controller includes data storage which stores a minimum pixel value for each of the defined unit areas to filter out scrub medium on the sample.

7. The wear test system of claim 4, wherein the scrub medium includes a dye so that the scrub medium is discernable from the base surface.

8. The wear test system of claim 4, wherein the scrub medium delivery system comprises a peristaltic pump that is connected to controller, which controls a volume of scrub medium dispensed on the sample at user defined intervals.

9. The wear test system of claim 1, further comprising an image display connected to controller to display the composite data.

10. The wear test system of claim 1, wherein the controller applies a threshold value to the time evolved composite data for visualization.

11. The wear test system of claim 1, wherein the controller calculates at least one of the following v. stroke of the scrub device; (a) total worn area, (b) a subregion width, and (c) a subregion length.

12. The wear test system of claim 1, further comprising a sensor on the scrub machine which transmits a signal to the controller so that imaging of the sample by the camera can take place at a defined interval.

13. A method of testing and monitoring wear of sample including a test material located on a base surface of a contrasting color, comprising:
scrubbing the test material on the base surface with a scrub device;
imaging at least a portion of the test sample at defined intervals with a camera, generating image data;
transmitting the image data to a controller;
creating time evolved composite wear data for wear of the test material from the sample.

14. The method of claim 13, further comprising:
delivering a scrub medium to the scrub device.

15. The method of claim 14, wherein the image data is collected for defined unit areas which encompass at least a portion of the sample and the step of creating time evolved composite wear data further includes storing the minimum color value for the base material for each defined unit area to filter out the scrub medium.

16. The method of claim 13, further comprising applying a threshold color value to the time evolved composite wear data for each of the defined unit areas.

17. The method of claim 13, further comprising displaying the time evolved composite wear data in graphic form

18. The method of claim 13, further comprising calculating at least one of the following v. stroke of the scrub device in the controller:(a) total worn area, (b) a subregion width, and (c) a subregion length.

19. The method of claim 13, wherein the image data is collected for defined unit areas which encompass at least a portion of the sample and the step of creating time evolved composite wear data further includes storing the minimum color value for the base material for each defined unit area to filter out the scrub generated debris.
